(19) United States
(12) Patent Application Publication
(10) Pub. No.: US 2002/0080032 A1
(43) Pub. Date: Jun. 27, 2002

(54) Method and apparatus for identification and information retrieval regarding industrial facility components

(76) Inventors: Jerry M. Smith, Orinda, CA (US); Jeffrey M. Vance, Stanford, CA (US); Richard E. Lancey, Bay Point, CA (US)

Correspondence Address: Mitchell S. Rosenfeld, Esq., c/o Law Offices of Gregory Scott Smith, Suite 317, 3900 Newpark Mall Road, Newark, CA, 94560, US

(21) Appl. No.: 09/746,946

(22) Filed: Dec. 21, 2000

Related U.S. Application Data
(60) Provisional application No. 60/216,766, filed on Jul. 6, 2000.

(51) Int. Cl. G08B 13/14

(52) U.S. Cl. 340/572.1; 340/568.1; 340/571; 340/10.1; 340/539

(57) ABSTRACT

The present invention is an asset identification and information retrieval system for industrial facility components composed of a computer identifier and at least one transponder tag. The transponder tags emit a radio identifier signal in response to a scanning signal sent by the computer identifier. The computer identifier is portable, battery operated and has visual displays for confirming readouts as well as a database to store multiple tag information. The system also has the capability to remotely access databases regarding tagged components, such that a field employee utilizing the computer identifier can communicate with the centralized control system to receive, amend or record records and other information regarding any particular tagged asset.

### RELATED APPLICATIONS

This application claims priority from Provisional Patent Application No. 60/216,766 filed on Jul. 7, 2000.

### BACKGROUND OF THE INVENTION

1. Field of the Invention

The present invention generally relates to positive identification of industrial and other hardware components and more particularly to the use of a radio frequency identifier based tagging system coupled to an information retrieval and logging database so that the user or facility can easily record and access critical component data.

2. The Prior Art

Major industries as well as industries related by similar needs have relied upon visual or optical methods for positive identification of their component facility assets. The industries include, but are not limited to: chemical, power, petroleum, manufacturing, paper, pharmaceutical, biotech, food processing, beverage processing, mining, pipelining, water treatment, waste treatment, offshore platforms, emergency response, and ships.

The visual and optical identification of facility assets such as control valves, hand valves, safety valves, rupture valves, instruments (including all process instrumentation and factory automation instrumentation), piping specialties, electrical components, and equipment, relies on an un-obscured path between the assets identifier or tag and the reader. In many cases the reader is human and the method of identification is further compromised by human error. Tags are typically made of metal such as stainless steel, copper, brass, aluminum, phenolic and plastic. The tags are stamped or engraved with an identifying numeric, or alphanumeric code or tag number as indicated, to uniquely identify facility components.

Tags are attached to the facility asset via one of several methods. The most used method of attachment is a strap or wire tie, wherein a flexible metal wire or plastic tie is looped through a hole in the tag and through a portion of the facility asset and then secured by a clamp or by twisting. Another method relies on attaching the tag to the facility asset via use of mechanical or chemical fasteners such as rivets, screws, bolts or adhesives.

Optical methods of facility asset identification such as bar code readers are employed to reduce the human error factor in reading the tag. These methods fall short of providing consistent positive identification due to the many factors that interfere with the optical path between the reader and the tag. For this method of identification, bar code tags are affixed to metal, plastic or phenolic tags and attached to the facility asset as previously described. When bar code readers are capable of making correct readings, it enables accurate transfer of the tag information via memory in the reader for use with centralized databases or printed documentation.

Tag and reader visual/optical interfacing is typically compromised by a number of external factors. Facility painters paint over and cover tags and bar codes. Sunlight fades bar codes and breaks down plastics in tags and ties. Metal tags break off from their ties from rough maintenance or due to repeated flexing of the metal wire or from corrosion caused by the process. Weather conditions such as ice showers and snow cover tags. Leaking process material builds up and covers tags. The temperature of the tagged asset can result in build up of ice over the tag. Regular dirt and grime from the environment can cover tags to the point of making them unreadable.

The need and importance of correctly and positively identifying facility assets varies depending on the facility, the asset, and the needs of the user. In the major industries listed, the value of correctly identifying a valve, instrument, or equipment asset, can mean the difference between safe or unsafe operations or prevent releases of pollutants to the environment. Correct identification also can insure correct maintenance and operations procedures, and provide a quicker way to find the needed engineering data for replacement or duplication of the asset. Quick and accurate identification of facility assets reduces personal injury, saves time and money for the facility, and mitigates environmental impacts.

When utilizing current identification methods, after obtaining and verifying the asset, users typically have to gather information to enable them to perform one or more functions. These functions are determined by the facility and type of user, and include operational, maintenance, or safety functions. Currently, field computers are limited in functionality and/or are bulky. Due to this inconvenience, most field personnel manually record field information and return to the office or control room to further investigate asset information utilizing centrally archived information. Typically, a full component asset identification and research project, involving just one asset, takes from 1 to 2 hours to generate a specific, useful report. If the asset is at the cause or branch cause of an emergency operating situation or facility shutdown, every minute saved can mean a safer recovery of the operation, less loss to the facility, and less spillage or release to the environment.

Manual operations represent an area of major concern to most industrial facilities. Until now there has been no connection between a facilities' automation control and its manual operations. Increasingly, systems that can reduce errors from manual operations, or improve reliability from advanced maintenance and operational procedures, are being mandated by insurance companies and government agencies, for facilities under their jurisdiction. As examples, the US Food and Drug administration requires verification and validation of compliance to pre-approved procedures at facilities under its auspice, and the US Chemical Safety Bureau, a newly founded Branch of the EPA was recently chartered to develop improvements to the safety of chemical facilities.

### SUMMARY OF THE INVENTION

The invention relates specifically to a facility asset marker identification system for permanently marking and identifying industrial equipment, valves, instrumentation, and such, utilized in conjunction with a portable reader/decoder unit coupled to a field accessible database for providing instant, accurate data regarding, but not limited to, the asset's technical, maintenance, mechanical, process, operational, safety, and commercial information in a portable field device for use by, but not limited to, technicians, operators, maintenance personnel, contractors, safety personnel, emergency response teams, engineers, management, and facility commercial personnel.

The present invention provides in its preferred embodiment, the method, hardware, and software, to tag assets utilizing specialized RFID tags, a device to acquire the digital identifying number from the tag, and relate the acquired digital identifying number to new or existing databases of information relating to the asset. Additionally the present invention enables a centralized control system to communicate with the device to receive and or record, records of manual actions, direct manual actions, and provide real time advisements regarding any particular asset. This provides users with information regarding location and directions to find any particular asset located within its accessible databases.

Accordingly, it is a principal object of the preferred embodiment of the invention to provide the method and means to consistently, and positively identify specifically tagged facility assets within any facility, eliminating all prior problems associated with visual or optical asset identification.

It is an additional object of the invention to provide the method and means to relate the asset identification to databases of information relating to the asset and to make such information available to the user.

It is an additional object of the invention to provide the method and means for a field user to access the most current operating instructions relating to any facility asset, and record the manual action that the user has performed relating to the facility asset.

It is an additional object of the invention to provide the method and means to provide physical location information to enable the user to quickly locate the facility asset based upon user known information regarding the asset.

It is an additional object of this invention to record and log the manual actions of a password identified user has performed to an identified tagged asset.

It is an additional object of the invention to provide the method and means to provide a search for the databases to provide the user with information presented in formats pertinent to the users field or specific needs

### BRIEF DESCRIPTION OF THE DRAWINGS

FIGS. 1 through 6 of the drawings depict the preferred embodiment of the present invention for the purpose of illustration only. One skilled in the art will readily recognize from the following discussion that alternative embodiments of the structures and methods illustrated herein may be employed without departing from the principals of the invention described herein.

FIG. 1 is a perspective view showing the individual hardware components of the portable tag reader, including the sensor assembly, the docking station assembly, the carrying case and a transponder tag.

FIG. 2 is a detailed perspective view of the portable tag reader sensor assembly.

FIG. 3 is an exploded view of the portable tag reader docking station assembly, showing the decoder box assembly, cradle communicator, power assembly, field database computer and the sensor assembly.

FIG. 4 is a schematic block diagram indicating how the descriptive signal passes between the hardware and components.

FIG. 5 is a flow chart illustrating tag reader operations.

FIG. 6 is a perspective drawing showing operation of the system of the present invention.

### DETAILED DESCRIPTION OF THE PREFERRED EMBODIMENTS

The system of the present invention includes hardware, (facility asset tags, a sensor assembly, and optionally a wireless communication device enabling local and/or Internet based server access), docking station assembly, including field database computer with software application programs, (operating systems, and interfacing to existing facilities database information), and set up methodology. The system's objective is to provide a consistent, accurate and irrefutable method for acquiring and displaying component asset identification, in even the harshest industrial applications. Once the identification is made, the system will automatically access a database of information regarding the component asset, and display such information, as requested, to a hand held unit at the field location. In addition the system allows the facility to direct and log manual operation of any assets for verification of compliance with instructions or procedures regarding an asset or group of assets via the use of the portable tag reader unit and the asset tags. In another application, users can quickly locate an asset by inputting the tag number and then requesting the location, within the facility on the field database computer. When the user gets to the location, they utilize the invention to verify that the correct asset has been found.

The tags utilized by the invention are based upon existing technology that has unique applicability to the preferred embodiment of the present invention. There are certain requirements for the radio frequency identifier (RFID) tags used as facility asset identifier tags for this invention. Firstly, they can only be tags designed for compatibility to perform RFID reads in a ferrous metal environment, like the environments that make up the majority of the facility situations for which the invention is intended. Secondly, the invention can only utilize tags that comply with a minimum read distance of six inches or more when utilizing a portable tag reader, in a ferrous metal environment. Thirdly, each tag is manufactured to have a unique 16 character, alphanumeric digital identifier signal that is received by the portable tag reader. Fourthly, the tags need to be chemically inert, capable of operating in ambient temperatures from −40 degrees fahrenheit to +150 degrees fahrenheit, and hardened to withstand impacts. The tags utilized in the preferred embodiment are those produced under U.S. Pat. Nos. 5,050,292; 5,084,699; 5,198,807; 5,223,851 and 5,281,855 by the Trovan Co., which are the only commercially available tags that are effective when mounted directly to a ferrous surface.

The tags can be secured to the facility asset utilizing current technology methods such as a fire resistant, high tensile, chemical resistant, positive securing, tie or wrap. In some instances the invention will utilize stainless steel bolting, riveting or screws to permanently attach the tag to the asset. The intention of the fastening method is to assure that the tag cannot be separated from the asset. In the preferred embodiment of the invention, a specifically designed ‘tie’ will assure a permanent attachment to the facility asset and/or tags will be sent to original equipment providers for embedding or encapsulating within the asset's structure.

Referring now to the Drawings, in which like or similar elements are given consistent identifying numerals throughout the various drawings, the portable tag reader component of the invention is a composite device of existing technology items, bundled together in a compact rugged case to meet the needs of industrial users. The major interface components are connected via special RS232 communications wiring, hard wired to the detection/decoder board and utilizing a cradle plug to attach to the removable field database computer component.

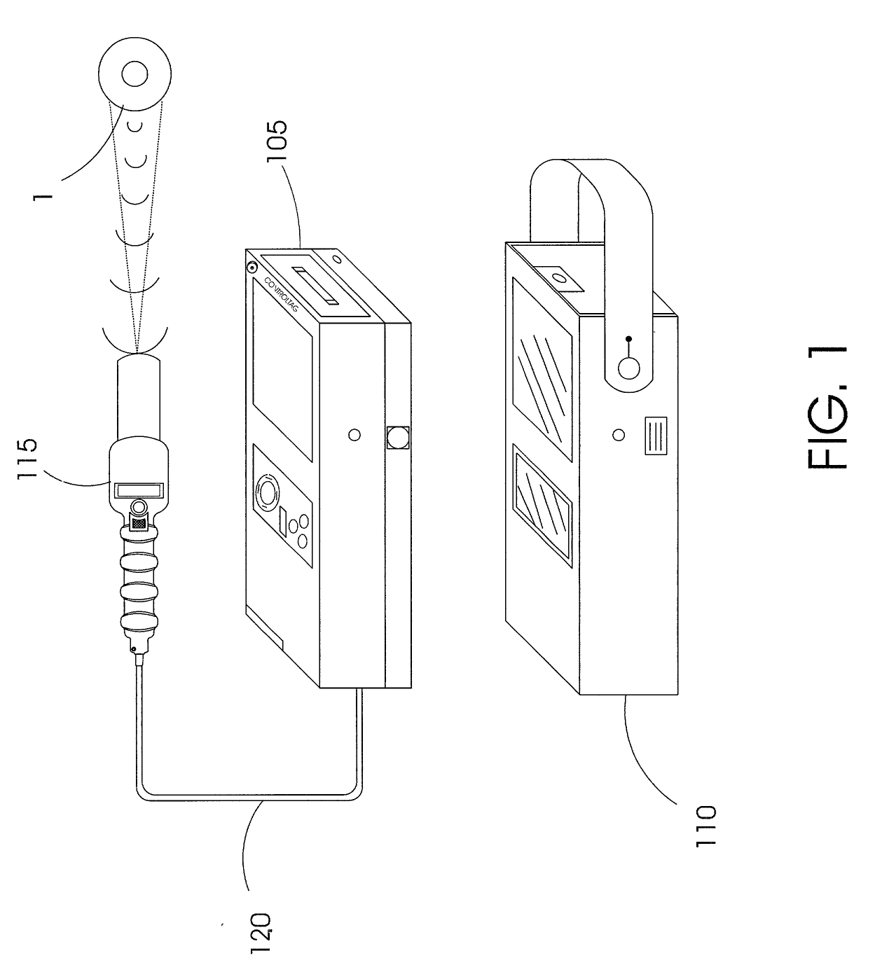

FIG. 1 shows the major components of the system including field asset tag 1, the sensor assembly 115, docking station assembly 105 and carrying case 110. Docking station assembly 105 is attached to sensor assembly 115 via sensor cable 120.

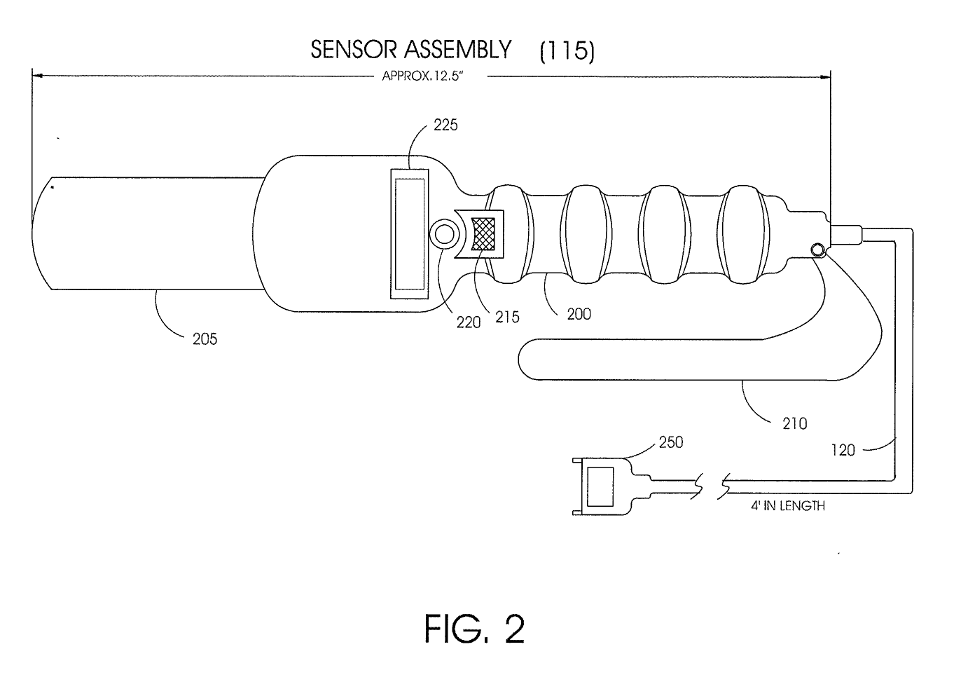

FIG. 2 shows sensor assembly 115 in detail. Sensor assembly 115 includes a non-slip rubberized grip handle 200 and antenna 205. A wrist cord 210 is attached to grip handle 200 to prevent drops. Sensor assembly 115 also contains activation button 215, a light emitting diode (LED) indicator 220 and, optionally, a liquid crystal display (LCD) 225. Sensor cable 120 is also shown. Sensor cable 120 includes connector 250 at the distal end of sensor cable 120 to enable connection to docking station assembly 105.

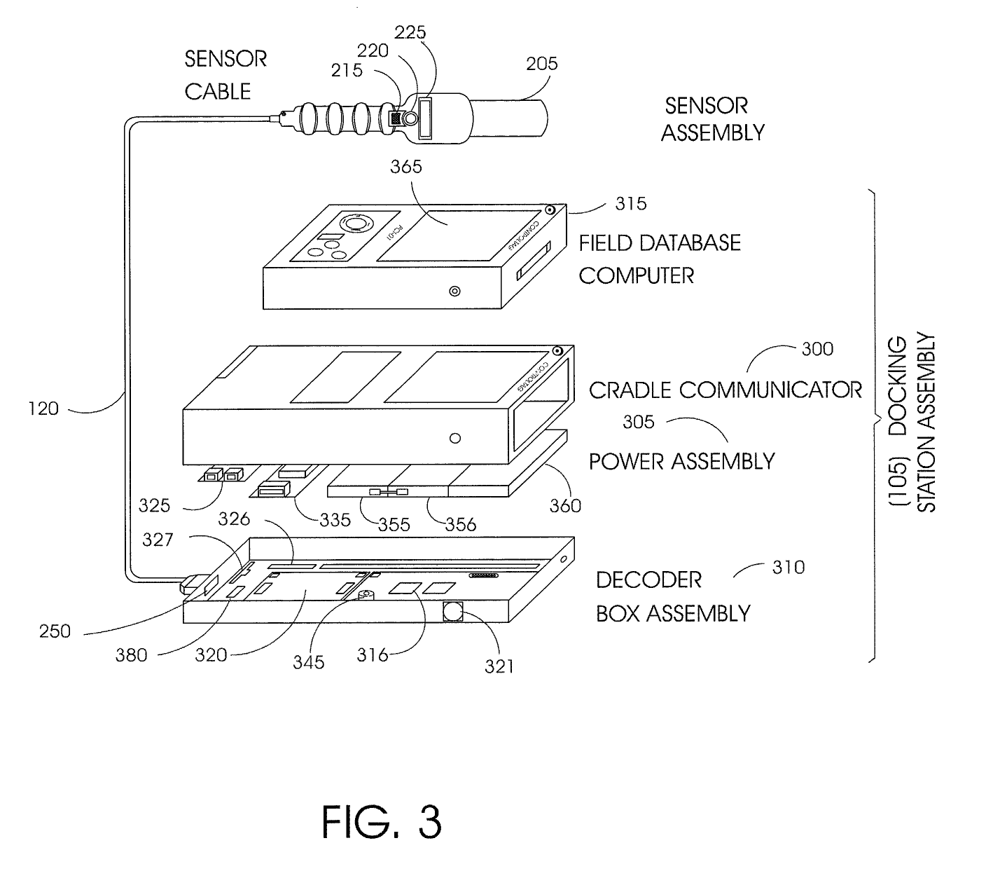

FIG. 3 shows an exploded view of the portable tag reader invention broken into its discreet pieces. Referring to FIG. 3, shown is sensor assembly 115 and docking station assembly 105 comprising field database computer 315, cradle communicator 300, power assembly 305 and decoder box assembly 310. Decoder box assembly 310 contains decoder board 316, code operated port switch 320, signal conditioner 335, and charging circuit 325. Decoder box assembly 310 is connected to field database computer 315 via integrated communications connector 380. Sensor assembly 115 is attached to decoder box assembly 310 through sensor cable 120 through connector port 250. From decoder board 316, the signal is fed to code operated serial port switch 320, then to the signal conditioner 335, then through the communications connector 380, and finally to the field database computer 315.

Power is supplied for all electronic component boards through system batteries 355, 356, and 360. Screen 365 on field database computer 315 initially displays information for tag 1 read by sensor assembly 115 and an audible signal (beep) is emitted from audio indicator 345.

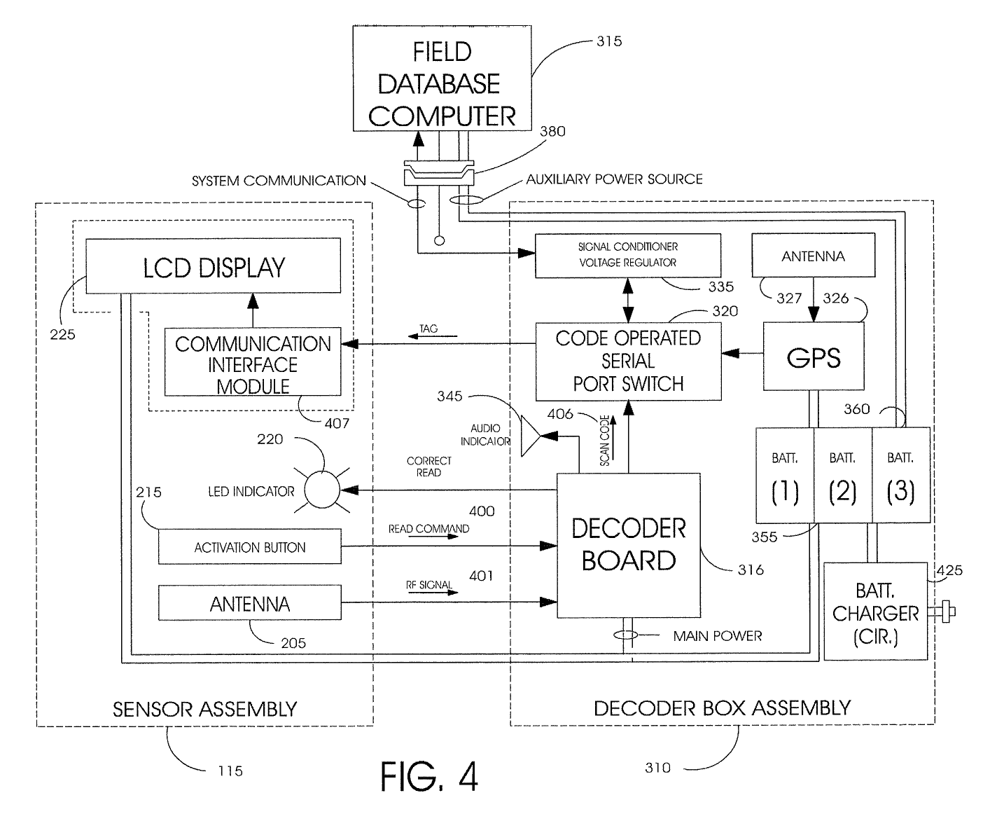

Referring now to FIG. 4, the schematic block diagram, the read sequence is initiated by pressing activation button, 215. This triggers read command 400 which triggers decoder board 316 to read the targeted tag. The tag's signal is received via antenna 205 and the radio frequency signal 401 transferred to decoder board 316. Digitally encoded radio frequency signal 401 is converted by decoder board 316. After six continuous successful scans, scan code 406 is transmitted to serial port switch 320 and simultaneously to LED indicator 220 and speaker 405 to create an audible beep.

The signal is then transmitted to the field database computer 315 via the signal conditioner 335, and then to communications connector 380. The digital code is referenced to the correct asset tag identification number which is then transmitted back through signal conditioner 335 to code operated serial port switch 320 to communication interface module 407 and LCD display 225 of sensor assembly 115.

Sensor assembly 115 can be built into carrying case 110 or supplied as a separate hand held unit as shown in FIGS. 1 and 2 with its own LCD display 225, activation button 215, and LED indicator 220. In the preferred embodiment, a separate hand held sensor assembly 115 is shown (FIGS. 1, 2 and 3). The components share a power supply provided by system batteries 355, 356, and 360 via the plugs and wiring from the docking station assembly 105. System batteries 355, 356, and 360 are rechargeable utilizing existing technology.

The invention utilizes radio frequency identifier decoder boards 316, commercially available from Trovan, but modified to meet the preferred embodiment's specific needs to match the transponders used as tags. Decoder board 316 is compatible with tag 1 and meet the following criteria. First, the decoder board must be compatible with the radio frequencies at which the transponders operate. Second, the decoder board must be able to communicate via a RS232 communications port. Third, the decoder board must be small enough to meet the bundling requirements of a portable tag reader. Fourth, the decoder board must be able to support different types and configurations of antenna 205 to enable customization of the overall invention to specific environments (such as ferrous metal background environments). The preferred embodiment utilizes decoder boards and antennas from the Trovan Co. covered by U.S. Pat. Nos. 5,012,236 and 5,198,807.

Referring to FIGS. 3 and 4, power assembly 305 and decoder box assembly 310 are wired into cradle communicator 300. Decoder board 316, system batteries 355, 356, and 360, signal conditioner 335, serial port switch 320, and charging circuit 325 are wired into decoder box assembly 310. Field database computer 315 commercially available and/or customized to specific invention requirements, is inserted into cradle communicator 300. Field database computer 315 should satisfy the following criteria. First, it should be capable of supporting large on board memory. Second, it should utilize an operating system that can be modified to meet the specific needs of this invention. Third, it should have a touch screen large enough to accommodate users wearing gloves. Fourth, it should be capable of utilizing additional miniature memory storage devices to further extend the capabilities for retaining data. Fifth, it should be capable of communications through a cradle capable plug using a RS232 system. Sixth, it should be manufactured rugged enough to meet the industrial needs of the invention. For purposes of describing the invention this application will show a Casio brand field database computer running an invention modified version of Windows CE operating system, although other commercially available personal data assistants could be used.

Software utilized by the invention includes an operating system that utilizes minimum amounts of memory within field database computer. It must be able to be modified to meet the needs of the invention, and must be compatible with existing major software packages. Software packages for programs operating on the field database computer must enable the invention to be flexible in the translation of other existing programs to be used with the invention and allow customization of the software to meet specific requirements of different facilities.

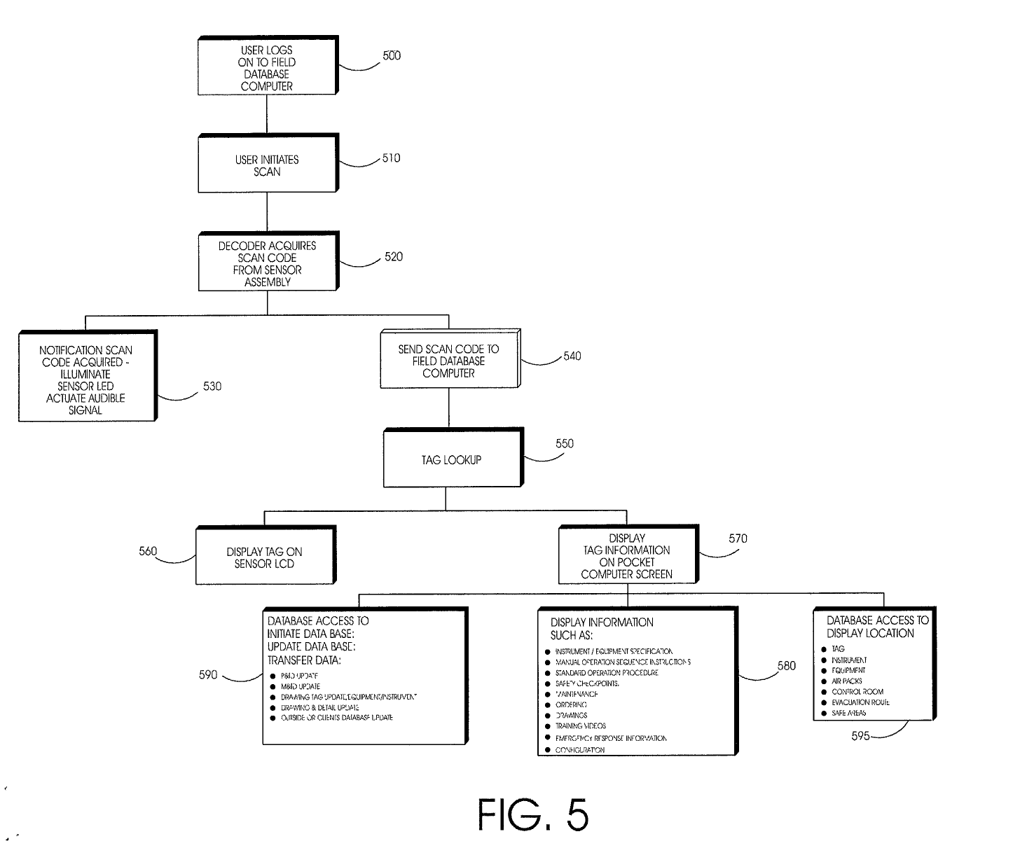

FIG. 5 shows a further depiction of how the software will be utilized to retrieve and display pertinent data. For purposes of demonstrating the invention this application is described utilizing modified versions of Microsoft's Windows CE operating platform, and Microsoft's ACCESS and SQLServer Database programs. It is not intended to specifically limit the invention to utilizing these specific brands of software. The FIG. 5 operations flow diagram describes the process steps taken when a typical user interacts with the invention from the viewpoint of the software.

The first step is user log on 500 where the user would initially log on to field database computer 315. This guards against unqualified users modifying data. It also enables tracking of activities to a particular person.

Once there is a proper user log on 500, the user initiates scan 510 by pointing sensor assembly 115 at a tag 1 attached to an asset to be identified and depress activation button 215.

After six consecutive scans are achieved, scan code acquisition 520 occurs where a unique alphanumeric code is locked in by decoder board 316.

Next, decoder board 316 initiates user notification 530 of scan code acquisition 520 and illuminates LED 220 on sensor assembly 115 and activates audio indicator 345. This step notifies a user that scan 510 has successfully acquired a scan code 520.

Decoder board 316 then simultaneously sends 540 scan code 520 to field database computer 315. The field database computer 315 software, upon receiving scan code 520, initiates tag lookup 550 in the database to determine the facility asset tag information. Once tag lookup 550 is completed, the software switches the serial interface to LCD 225 and sends the facility asset tag to sensor assembly 115 for display 560. The software then switches the serial interface back to decoder board 316 to receive future scans.

Simultaneously, tag information, and optionally some minimal data, is sent to screen 365 on field database computer 315 for display 570. The field database computer 315 can then display information 580, at user request, regarding any available data related to the tag. This can include but is not limited to instrument/equipment specifications, manual operation sequence, instructions, standard operating procedure, safety checkpoints, maintenance, ordering, drawings, training videos, emergency response information, and configuration.

The user can also initiate database access 590 to initiate, update, or transfer data to an outside data source. This includes but is not limited to P&ID update, M&ID update, drawing tag update, drawing and detail update, and external database update. The user can also initiate a database access 595 to display the location of a tag, instrument, equipment, air packs, control room, evacuation route, safe areas or other locations.

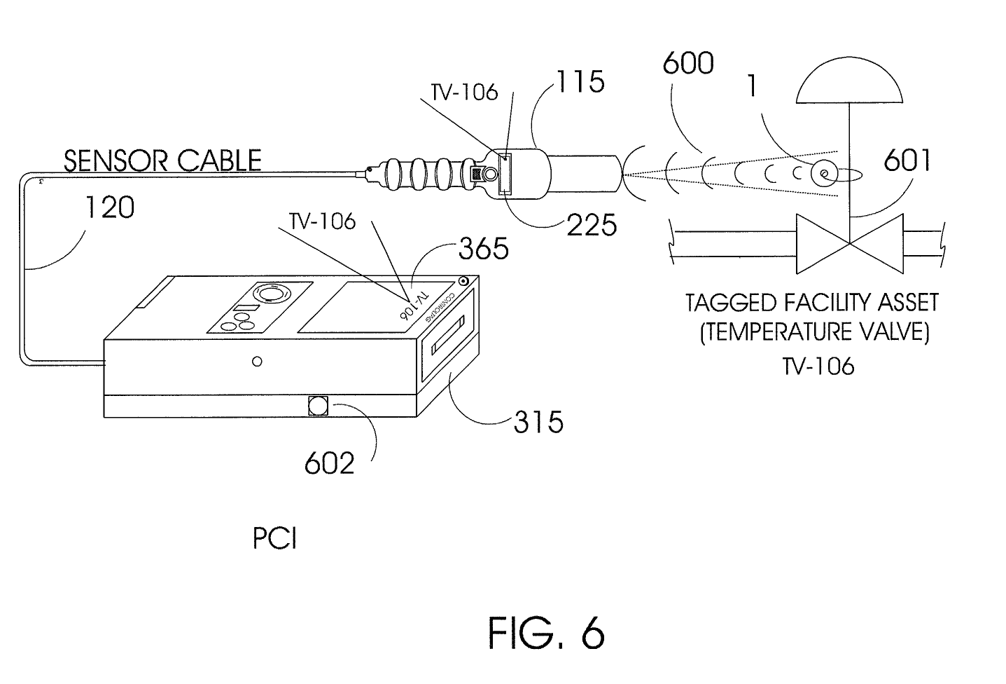

FIG. 6 illustrates how the invention will function when operated by the user. Shown is a typical facility asset, 601, for example, a temperature control valve with tag 1 affixed thereto. To identify tag 1 for asset 601, the user initiates a scan by depressing activation button 215 on sensor assembly 115 or by depressing alternate activation button 321. As depicted the temperature valve's tag 1, responds to scan 600 from sensor assembly 115. A unique digital code is received by sensor assembly 115, where it is processed through decoder board 316 and possibly other components, such as signal conditioner 335 for further processing prior to being sent to field database computer 315 where it is associated with the identification or number relating to tag 1. For purposes of this disclosure, an illustrative facility asset 601, TV-106 (temperature valve 106), is shown. The identification number relating to tag 1 is simultaneously displayed on LCD 225 of sensor assembly 115 and is also displayed on screen 365 of field database computer 315.

Six successful scans of the same digital signal returning from tag 1 are required before decoder board 316 acquires scan code 520 and activates send 540 to transmit the corresponding alphanumeric code to field database computer 315 as an input to conduct tag lookup 550. This input activates field database computer 315 to conduct tag lookup 550 to access the database and display the associated asset tag identification number as assigned by the facility. The facility asset tag identification number is displayed on screen 365 on field database computer 315 and/or on LCD 225 on sensor assembly 115. The initial information displayed is decided upon by the programming of the database as designed into the software.

The digital signal received by sensor assembly 115 in response to a scan of facility asset tag 1 is unique to the facility asset tag and no two facility asset tags at the same facility have identical digital signals. The digital signal related to a tag is associated with a tag number and information that is assigned by the facility through the database. It is the facility asset tag that relates the asset to the database of information accompanying that asset. It is the actual assigning and physical attachment of the tags to the correct facility asset that is the critical step in outfitting a facility to use the invention. This activity must be done with trained professionals utilizing a set procedure of checks and verifications to assure that assets are correctly identified and related to the database via the corresponding facility asset tag.

Referring to FIG. 4, in the preferred embodiment of the invention decoder box assembly 310 also includes global positioning system 326 (GPS) and antenna 327. Antenna 327 allows field database computer 315 to interface directly with a centralized computer system via direct signal coupling or through the Internet. This would allow the invention to send and receive virtual real time updates, instructions, or responses, and allow a centralized computer system to note and record manual activity responses from a user. The 326 inputs the user's location and relates the user location to asset locations within the facility.

From the above description, it will be apparent that the invention disclosed herein provides a novel and advantageous asset identification and information retrieval system. The foregoing discussion discloses and describes merely exemplary methods and embodiments of the present invention. One skilled in the art will readily recognize from such discussion that various changes, modifications and variations may be made therein without departing from the spirit and scope of the invention. Accordingly, disclosure of the present invention is intended to be illustrative, but not limiting, of the scope of the invention, which is set forth in the following claims.

We claim:

1. An asset identification and information retrieval system for industrial facility components comprising:
a tag reader;
at least one transponder tag;
a centralized database.

2. The asset identification and information retrieval system for industrial facility components as claimed in claim 1, wherein the tag reader is portable.

3. The asset identification and information retrieval system for industrial facility components as claimed in claim 1, wherein the tag reader further comprises a separate sensing unit.

4. The asset identification and information retrieval system for industrial facility components as claimed in claim 3, wherein said separate sensing unit includes an independent read out screen, activation button and LED indicator.

5. The asset identification and information retrieval system for industrial facility components as claimed in claim 1, wherein said computer identifier is a wireless communication device.

6. A method for identifying assets and retrieving information for industrial facility components comprising the steps of:
scanning a coded transponder tag;
deriving from said scan a digital code;
using said digital code in conjunction with a master database to provide information related to a tagged asset.

7. An asset identification and retrieval system for industrial facility components comprising;
means for retrieving coded identification information from a tagged asset;
means for matching said coded information with a master database of information in order to provide or amend detailed information regarding said tagged asset.
